(19) United States
(12) Patent Application Publication
(10) Pub. No.: US 2026/0105706 A1
(43) Pub. Date: Apr. 16, 2026

(54) SYSTEM AND METHOD FOR 3D FACE REPLACEMENT

(71) Applicant: CANON KABUSHIKI KAISHA, Tokyo (JP)

(72) Inventors: Xiwu Cao, Irvine, CA (US); Jeanette Yang Paek, Los Alamitos, CA (US); Jason Mack Williams, Huntington, NY (US)

(21) Appl. No.: 19/120,740

(22) PCT Filed: Oct. 19, 2023
(86) PCT No.: PCT/US2023/077295

§ 371 Date: Apr. 11, 2025

Related U.S. Application Data
(60) Provisional application No. 63/380,435, filed on Oct. 21, 2022.

(51) Int. Cl. G06T 19/20; G06T 7/11; G06T 7/149; G06T 7/174; G06T 7/40; G06T 7/564

(52) U.S. Cl. CPC G06T 19/20; G06T 7/11; G06T 7/149; G06T 7/174; G06T 7/40; G06T 7/564; G06T 2207/30201; G06T 2210/56; G06T 2219/2004; G06T 2219/2021

(57) ABSTRACT

An information processing apparatus and method is provided and comprises one or more processors; and one or more memories storing instructions that, when executed, configures the one or more processors, to extract a portion of the identified replacement region in 3D source image, align a target 3D replacement image with the corresponding extracted region of the 3D source image, and generate an updated 3D image having the target 3D replacement image in the replacement region.

### CROSS-REFERENCE TO RELATED APPLICATIONS

This application claims the benefit of priority from U.S. Provisional Patent Application Ser. No. 63/380,435 filed on Oct. 21, 2022, the entirety of which is incorporated herein by reference.

### BACKGROUND

### Field

The present disclosure relates generally to image processing techniques for replacing portions of an image with another image.

### Description of Related Art

Techniques for performing 3D image replacement exist and the concept of 3D face replacement is useful in identity swapping. In so doing, the 3D face model that is used for replacement and the 3D face region that needs to be replaced are usually captured or estimated using same or similar approaches. This similarity between approaches used for both the replacing and the replaced 3D face makes them have a same 3D topology or similar meshes. This allows for there to be a similarity between meshes in their 3D topology which providers for a consistent 3D alignment and boundary determination for 3D face replacement.

### SUMMARY

An information processing apparatus and method is provided and comprises one or more processors; and one or more memories storing instructions that, when executed, configures the one or more processors, to extract a portion of the identified replacement region in 3D source image, align a target 3D replacement image with the corresponding extracted region of the 3D source image, and generate an updated 3D image having the target 3D replacement image in the replacement region.

In another embodiment, the one or more processors are further configured to detect a boundary for the extraction of identified region using domain knowledge characterizing the first rough region of the 3D image. In other embodiments, the one or more processors are further configured to detect a boundary for the extraction of identified region using one or more of a 2D boundary determination process and a 3D boundary determination process. Further embodiments provides that the one or more processors are further configured to refine the detected boundary by identifying an area in an image having a gap on meshes between boundary data, and filling the mesh gap using a local region surface process to re-define the replacement region. In yet another embodiment, the one or more processors are further configured to extract a portion of the identified replacement region by generating meshes corresponding to a first region representing the replacement region in a human head and a second region representing all other regions not including the face in the replacement region and execute watershed mesh splitting to extract the first region representing the replacement region in a human head.

In another embodiment, the 3D source image includes a head region and a body region, wherein the head region includes a front head region and a back head region and a location of the head region on a XY plane is identified based on a prebuilt 2D face model. Further, the one or more processors are configured to identify, as a rough replacement region in the 3D source image, the front head region based on a histogram of 3D points projected to Z axis which is vertical to the XY plane, the 3D points being points of the head region.

According to another embodiment, the one or more processors are further configured to perform alignment processing that includes first alignment processing and second alignment processing. In the first alignment processing, the one or more processors is configured to apply 2D alignment based on the identified replacement region and the target 3D replacement image, and in the second alignment processing, the one or more processors is configured to apply 3D alignment based on the identified replacement region and the target 3D replacement image.

In a further embodiment, after the target 3D replacement image and the identified replacement region of the 3D source image are aligned, the one or more processors are configured to search boundary points from the identified replacement region in 3D source image and the one or more processors are configured to determine a boundary by obtaining gap-filling 3D points by connecting the searched boundary points and the gap-filling 3D points.

In an additional embodiment, the one or more processors are configured to perform the replotting the boundary points which includes identifying two neighboring boundary points and third 3D point from one or more processors, wherein the two neighboring boundaries and the third 3D point configures a triangle mesh of the target 3D replacement image, defining local 3D coordinate system based on the identified two neighboring boundary points and third 3D point, projecting 3D points of the two neighboring boundaries in the local 3D coordinates, and obtaining the gap-filling 3D points by applying a predetermined routing algorithm in the local 3D coordinates.

Another embodiment includes the one or more processors being configured to perform receiving a plurality of the target 3D replacement images, selecting one of the plurality of the target 3D replacement images, and aligning the selected target 3D replacement image with the corresponding extracted region of the 3D source image, wherein a target 3D replacement image which is not selected is aligned to a corresponding extracted region of the 3D source image using the result of the alignment of the selected target 3D replacement image.

In yet another embodiment, the one or more processors are configured to perform receiving a plurality of the target 3D replacement images, selecting one of the plurality of the target 3D replacement images, and aligning the selected target 3D replacement image with the corresponding extracted region of the 3D source image, wherein the obtaining of the gap-filling 3D points in the local 3D coordinates is performed for the selected target 3D replacement image and the obtaining of the gap-filling 3D points in the local 3D coordinates is not performed for a 3D replacement image which is not selected, and wherein a target 3D replacement image which is not selected is aligned to the corresponding extracted region of the 3D source image using the result of the obtaining of the gap-filling 3D points for the selected target 3D replacement image.

Other embodiments include a method of performing any and all steps described above with respect to operations of the one or more processors as well as computer readable storage mediums that store instructions, code, programs or other logic that configure a device or apparatus to perform the operations described herein.

These and other objects, features, and advantages of the present disclosure will become apparent upon reading the following detailed description of exemplary embodiments of the present disclosure, when taken in conjunction with the appended drawings, and provided claims

### BRIEF DESCRIPTION OF THE DRAWINGS

FIGS. 1A-1C illustrates an exemplary issue to be resolved by the present disclosure.

FIG. 2 illustrates an exemplary algorithm for performing 3D face replacement on an image according to the present disclosure.

FIG. 3A-3C illustrates exemplary results of a determination of the 3D face region according to the present disclosure.

FIGS. 4A & 4B illustrates exemplary results of a determination of the 3D face region based on 2D and 3D alignment according to the present disclosure.

FIGS. 5A-5F illustrates exemplary results of a boundary determination according to the present disclosure.

FIG. 6A-6E illustrates exemplary watershed based mesh splitting according to the present disclosure.

FIG. 7 illustrates the process of generating the resulting image according to the present disclosure.

FIG. 8 illustrates an algorithm for real-time dynamic 3D face replacement according to the present disclosure.

FIG. 9 illustrates exemplary hardware that is configured to execute the face replacement algorithm according to the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples.

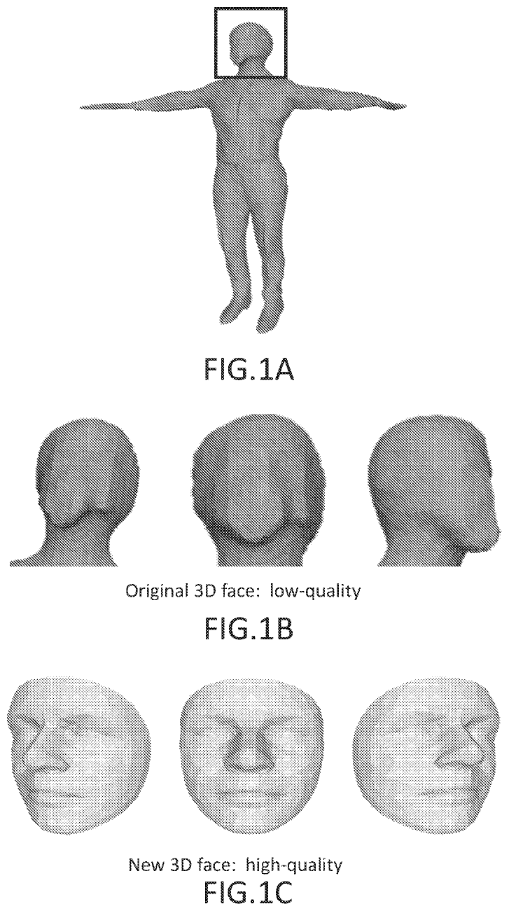

FIGS. 1A-1C illustrate an exemplary manner of 3D object replacement and the deficiencies associated therewith. In operation, there is a need to replace one portion of a 3D object using another 3D portion. For example, a portion of the 3D object could suffer from a low quality distortion, but we have a similar 3D portion that is of high-quality. It is desirable to replace the low-quality 3D distortion with a high-quality 3D content. Another example could be that the original 3D object is estimated from a 2D image purely based on a predictive model. In a case there exists a high-quality 3D portion that is solidly captured through a volumetric capture processing such as those performed using MICROSOFT® Azure Kinect or INTEL® RealSense, a 3D replacement source such as this yields an improved result. Thus, replacing the corresponding estimated imaginary 3D portion with a better trustworthy hardware-captured 3D content is preferred.

One example is shown in FIG. 1A-1C . In this example an application that has low-quality 3D face image that is shown within the boundary of the box in FIG. 1A is to be replaced by a high-quality 3D face. FIG. 1A shows a 3D human body that is estimated based on a third-party human body estimation library such as Pifu. As can be seen in FIG. 1A, although the whole body shows a decent 3D topology, the face region (within the box) on the head of the body has a very low 3D quality. For example, the area that is known to be face does not exhibit or show any facial features such as eyes, nose or mouth. This low quality face portion is illustrated in FIG. 1B which represents a zoomed in view of the face from FIG. 1 A illustrated in three different orientations. As can been seen, none of the zoomed in orientations of the face portion visibly depict regions including any of eyes, nose, or mouth. As such, these regions are not easily identified.

While a sparse and rough 3D topology may be sufficient for a human body model as shown in FIG. 1A, the sparse data points are incapable of delivering the enough quality information needed for human perception to actually perceive a face. Therefore, a low-quality 3D face portion is to be replaced with a high-quality 3D face portion. FIG. 1C shows a high-quality 3D face estimated based on the same resource from a facial model library such as Mediapipe. While simple replacement may be performed, the result of simply replacing the face will not yield acceptable results due to human perception being advanced and because the region being replaced cannot be easily aligned with the replacing portion. It is not easy to directly make the face replacement between 1B and 1C because the portion that needs to be replaced does not have the exact same topology as the one used for replacing. For example, the number of vertices in face region do not match to each other, and the density of vertices is also different. Therefore, a face replacement algorithm according to the present disclosure resolves this problem by providing a mechanism for improving the alignment between an image to be replaced and the image being used for the replacement.

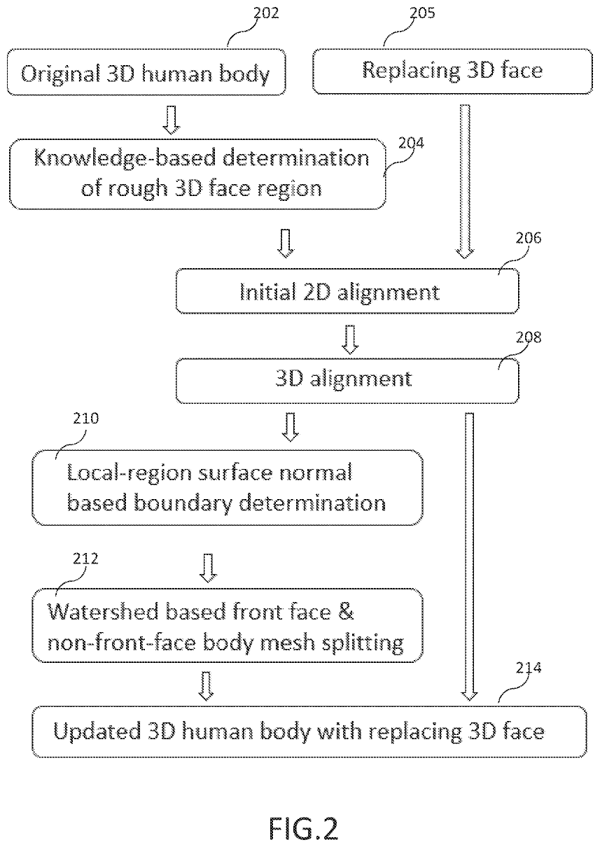

FIG. 2 illustrates an algorithm that solves the alignment issues noted above and improves the ability to perform 3D face replacement to improve resulting 3D image quality that may be used in a virtual reality application whereby a full 3D image of a user can be presented to other users in the virtual reality space. The algorithm includes a set of executable instructions stored in a memory that that executed configures one or processors to perform the operations described herein. In other embodiments, the instructions are embodied a executable program code or embodied as a library that is called during processing to perform the following operations.

FIG. 2 illustrates an algorithm representing the workflow for performing 3D face replacement according to the present invention. Given an original 3D human body 202 that is obtained from a storage device or is captured by an image capture device and a 3D face model 205 that is used for replacing the face of the original 3D human body, the algorithm locates a replacement region on the original human body model on which the placement processing is preformed. In some embodiments, the 3D face model represents a model of a human face of the user in the original image 202 that is captured during a precapture processing that is performed. As such, the replacement face 205 can be acquired from a storage device and be specifically associated with a user present in the original image 205. The replacement region may include one or both of the face region or front head. The replacement region is determined, in 204, based on our domain knowledge. For example, if the algorithm is configured to replace a face region, a face detection model is used to process the original image 202 to detect a face. In other words, the use of domain knowledge represents using the knowledge associated with a specific task or type of processing and obtaining or otherwise using functionality that performs that task. The face detection model used is generated using human domain knowledge in face recognition and is applied to a 2D image rendered from 3D human body and roughly separates the 3D head from other 3D human body based on the 2D X and Y coordinates. This separation advantageously provides a refined region in 3D human body for face alignment. Then two alignment techniques with one from 2D and the other from 3D are applied to find the initial sparse boundary of the 3D face region that needs to be replaced within original 3D human body. Once the initial sparse boundary of 3D face region is obtained, the algorithm executes, in 206-210, a local-region surface normal based boundary determination approach to find refined 3D face boundary points. From that, in 212, a watershed based front face and non-front-face body mesh splitting is applied to extract the human body that does not contain the front face region. This human body without face is then combined, in 214, with the aligned replacing face to generate the updated 3D human body with replacing 3D face.

The above overview described in FIG. 2 will now be described in more detail via the individual algorithmic processing performed by one or more processors that are configured, upon execution of instructions stored in a memory, to perform the below described numbered steps.

### Initial Boundary Estimation of Face Region From 3D Human Body

A replacement face 205 is a 3D face being used for image replacement processing. The first step of 3D face replacement is to locate 3D regions of the original image that needs to be replaced on the original 3D human body model image. Note that the original 3D human body and the replacement 3D face are often estimated using different approaches, and therefore, it is not clear the location of the 3D boundary of the 3D face region that needs to be replaced from the original 3D body model image. The presently described algorithm corrects for these differences and improves the alignment and the resulting replacement process.

In 204 in FIG. 2, an initial qualitative determination of 3D face region based on domain knowledge is performed. Because, a face region is only a small portion of the entire human body and since only the face portion of the original 3D image is targeted for replacement, it is computationally inefficient to search the whole 3D body for the corresponding 3D face region even though some 3D alignment algorithm, like ICP (iterative close point) allows for this processing to be performed. The present disclosed algorithm provides for a more efficient way is to utilize our understanding of the relationship between the face region and full human body region and effectively limit the possible 3D regions in the human body for search or alignment.

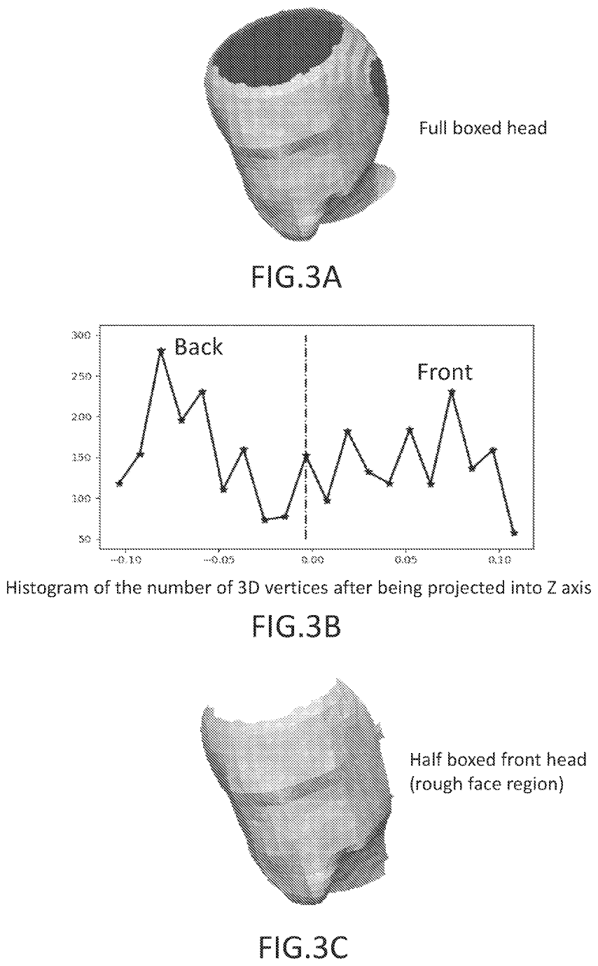

FIGS. 3A-3C illustrates an improved manner for locating the 3D face region, or as shown here, a front head region. This is performed based on how information corresponding to a human face is understood. In exemplary operation, the original 3D human body model is generated from a captured 2D image. In so doing, there exist certain executable libraries that provide prebuilt 2D face models (e.g. Mediapipe, dlib, or MTCNN) which analyze the input image and generate a bounding box that is positioned about the original 2D image (see, for example FIG. 1A). This enables a rough location the face region (or the head region) by applying the restrictions on the X and Y coordinates from 2D face bounding box. However, according to the present disclosure, the XY dimension of the bounding box region are expanded by a predetermined factor to allow some redundancy to cover all the possible XY variations from the originally applied bounding box. The 3D human head extracted from human body after applying the XY bounding box is shown in FIG. 3A.

FIG. 3A contains both the front head region and back (or rear) head region because there were no enforced restrictions on Z coordinates. However, a better location of the 3D face region is provided if the front head (or face) region is extracted alone. To extract the 3D points from front head, the 3D points of the whole head are projected onto the Z axis. The number of points for each Z value after being binned is shown in FIG. 3B. Since the 3D head was orientated with the front face being perpendicular to the camera direction, we expect to see two peaks in the histogram of number of points over its Z axis projection. One peak ‘Front’ corresponds to the front face of the head and the other ‘Back’ corresponds to the back face of the head. The values of the two peaks may be averaged as shown in the gray vertical line, to split the whole head region and extract only a front head region as shown FIG. 3C which is indicative of a rough location of the replacement region where image replacement of the 3D face region is to be performed. The front head extracted here, or rough replacement region, contains data used use for 3D face replacement. Generally, we want this determined rough replacement region to contain more space or region than an actual size region that is wanted. The following refined 2D and 3D alignment will refine this rough replacement region to generate a precise 3D boundary. The reason is that only x and y coordinates are used in 2D domain and it is difficult to have a precise splitting for a 3D object based only on x and y coordinates. Thus having extra room in 2D splitting improves the algorithms ability to not lose any information for the following 2D and 3D alignments.

### Alignment Processing Using Quantitative Determination of 3d Face Region Based

on 2D and 3D Alignment

After 204 in which the rough replacement region is identified by finding the 3D face region based on our domain knowledge, the algorithm performs quantitative location processing to locate the refined 3D face region from the roughly identified 3D face region based on 2D and 3D information between the replacement 3D face and extracted 3D face region.

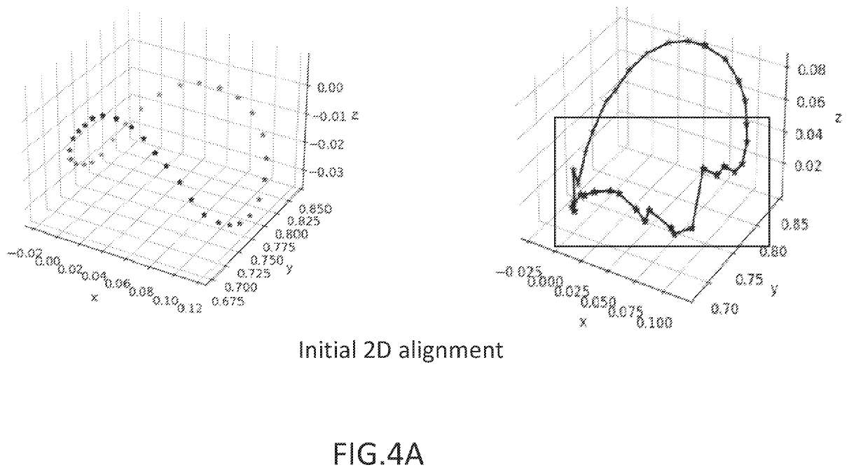

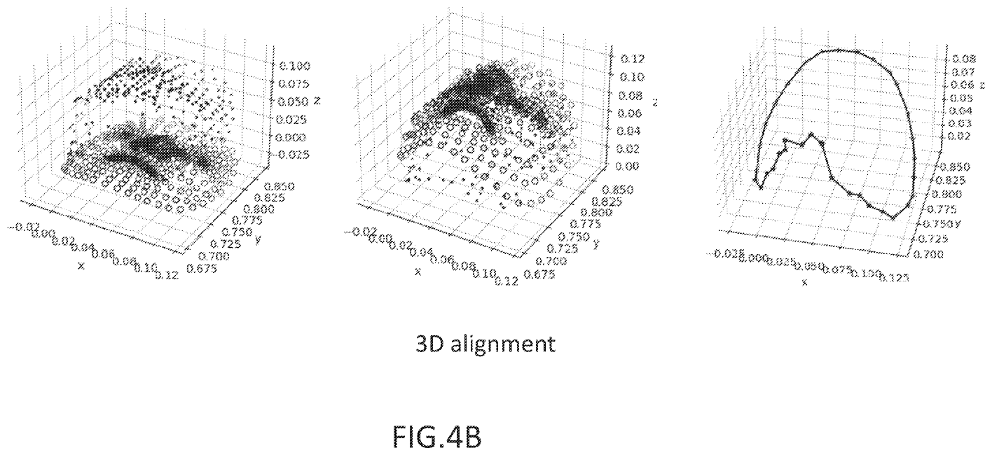

FIGS. 4A & 4B illustrate alignment processing performed including a first and second alignment processing that is used to align the target 3D face image used for replacement of the extracted 3D front head replacement region. First alignment processing 206 applies a 2D alignment based on X and Y information from the rough replacement region and the target 3D face image. First, the 3D boundary points are obtained from the target 3D face image used for replacement. This shown in the left image of FIG. 4A. Then, for each boundary point in the target 3D face image used for replacement, a search is performed for its corresponding 3D point within the extracted front head from the rough replacement region as defined by, for each point, a smallest distance in terms of X and Y information. The result is shown on the right image in FIG. 4A.

Although the majority of the searched boundary points in the extracted rough replacement image of the front head provide acceptable mappings to their boundary points in target 3D face image for replacement, there are still a large number of searched boundary points that do not make sense in terms of smoothness and soundness, particularly for those 3D points shown in rectangle area in the right image of FIG. 4A.

Thus, in 208, second alignment processing is applied using 3D alignment for all the available 3D points in the target 3D face image to be used for replacement. One example is shown in FIG. 4B. The left image shows both the original 3D points from both target 3D face used for replacement, shown in empty circle, and the corresponding 3D points extracted from the rough replacement region of the front head, shown in solid dots. Their correspondence is determined just based only their 2D information, or their X and Y coordinate values. The middle image of FIG. 4B shows both the original 3D face points extracted from the rough replacement image of the front head and the transformed 3D face points from the target image of the 3d face for replacement after first 3D alignment processing was applied based on a linear transformation. After first 3D alignment processing in 206 the corresponding boundary points from all the points available in extracted rough replacement region of the front head region based on all the information on X, Y, and Z in 3D space are searched. The result is shown in the right image in FIG. 4B. As can be clearly seen in the right image of FIG. 4B as compared to the right image of FIG. 4A, performing second alignment processing results in an improved 3D boundary determination of the target 3D face region used for replacement processing.

### Local-region Surface Normal (LRSN) Based Boundary Determination\

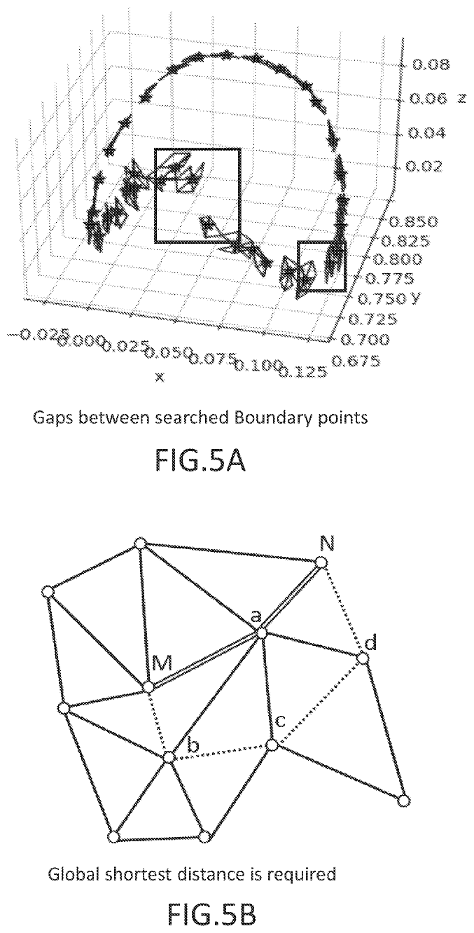

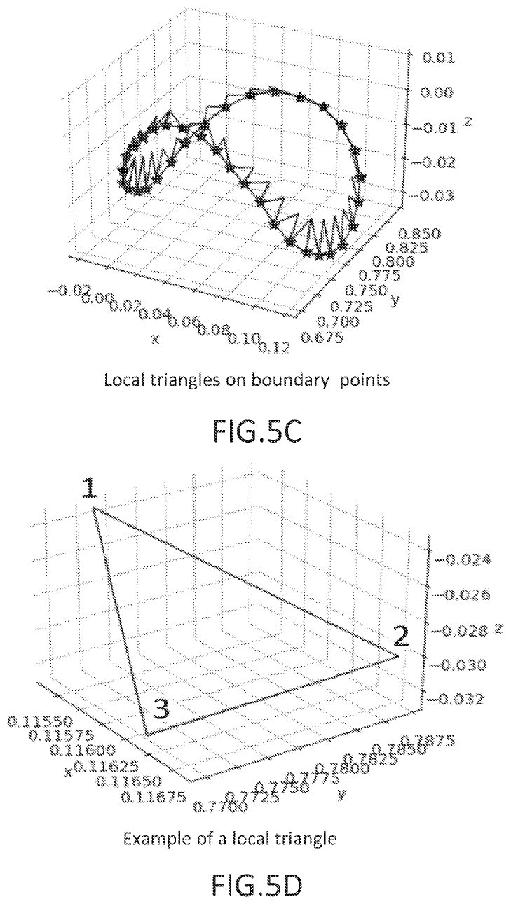

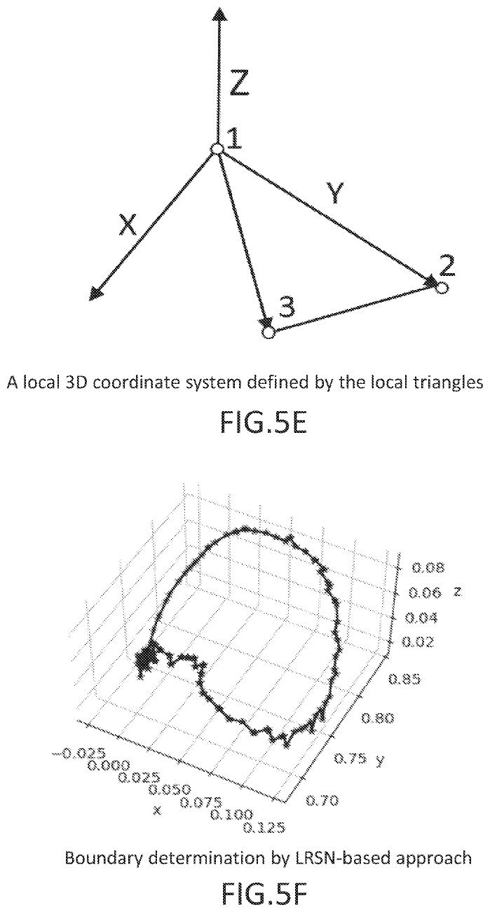

The searched 3D boundary points, shown on the right image in FIG. 4B, often cannot form a close mesh boundary due to the fact that there is a topology mesh difference between the 3D face region in original 3D human body and the target 3D face image used for replacement. The present algorithm improves this by providing better visibility by plotting the boundary points with their neighborhood meshes. This local region surface processing is performed in 210 and is illustrated in FIG. 5A-5F . As shown on FIG. 5A, all boundary points as well as all the triangle meshes associated with these boundary points are replotted. In the embodiment shown here, there are 36 boundary points but this is merely exemplary based on the output of prior processing steps and more or less boundary points may be obtained depending on the images being processed. By replotting these points and meshes, gaps in some neighboring boundary points are visualized as target areas for local processing. As shown in FIG. 5A, the gap regions are contained in the rectangle areas of FIG. 5A.

Local region processing is performed to refine the boundary points by filling the gaps for all those corresponding neighboring boundary points to make a sound close 3D topology for the face region in original human body image. In one embodiment, the algorithm refills regions by searching a sequence of 3D points between any two neighboring boundary points based on the shortest distance of any two 3D points. But, this provides challenges due to the computing performance required.

According the present disclosure, an improved process for searching and refilling the gaps is illustrated with respect to FIG. 5B. To connect two neighboring boundary points M and N, the route shown in dot line through pivots ‘b’, ‘c’, and ‘d’ might be the one we found based on the shortest distance between any two points. However, an ideal global solution should be the route through the pivot ‘a’ shown in double lines. Therefore, a minimum of global shortest distance between two neighboring boundary points may be enforced (for example, using Dijkstra's algorithm).

However, a general global solution like Dijkstra's algorithm will also provide less desirable results. Instead, the present algorithm further improves on this by using not just a globally shortest distance from all those gap-filling points, but also those gap-filling 3D points should form a similar 3D mesh topology to the local topology formed by the 3D boundary points in the target 3D face image being used for replacement. Thus, the present disclosure executes a local-region surface normal (LRSN) base boundary determination method to allow those gap-filling points to form a similar 3D mesh topology. In operation, for a total number of boundary points (as shown herein, 36 boundary points) from the target 3D face image used for replacement, a total number of edges is obtained (here, 36 edges are obtained). For each obtained edge, corresponding triangle associated with this edge is obtained as can be seen in FIG. 5C. For more detail, a respective one of the obtained corresponding triangles is also shown in FIG. 5D. Here, points 1 and 2 are two neighboring boundary points sorted in a clock-wise order from the target 3D face imaged used for replacement when the person faces to the camera. Point 3 is the associated 3D point in the searched triangle.

Then for each triangle, a 3D coordinate system is defined as illustrated in FIG. 5E which shows a 3D coordinate system defined from three points 1, 2 and 3. First, the Y axis is defined as the vector from point 1 to point 2 with the positive sign being assigned in a clock-wise order. Then X axis is computed based on the point 3 and Y axis. The positive of X axis was defined based on the sign of the projection of point 3 to X axis. Point 3 should always have a positive X sign in its projection to X axis. Once the positive X and Y were defined, the positive Z axis is calculated based on a right-hand rule.

Once all local 3D coordinate system are defined, all 3D points within the neighborhood of points 1 and 2 are projected into the XY plane of this local 3D space. After the projection, a similar local or global shortest distance method is applied obtain one or more improved 3D gap-filling boundary points. The overall final 3D boundary points from both the original 3D sparse boundary points and the gap-filling 3D points are shown in FIG. 5F.

### Watershed Based Mesh Splitting Between Front Face and Non-front-face Human Body

In response to determining and identifying close boundary points for the rough replacement region of the 3D face image obtained from the original human body model, mesh splitting processing is performed in 212 to extract an updated 3D human body without extracted front head region (or face region) from original entire human body model. This updated 3D model is combined with the target 3D face used for replacement to allow the algorithm to replace the 3D face region within the original 3D human body with the target image.

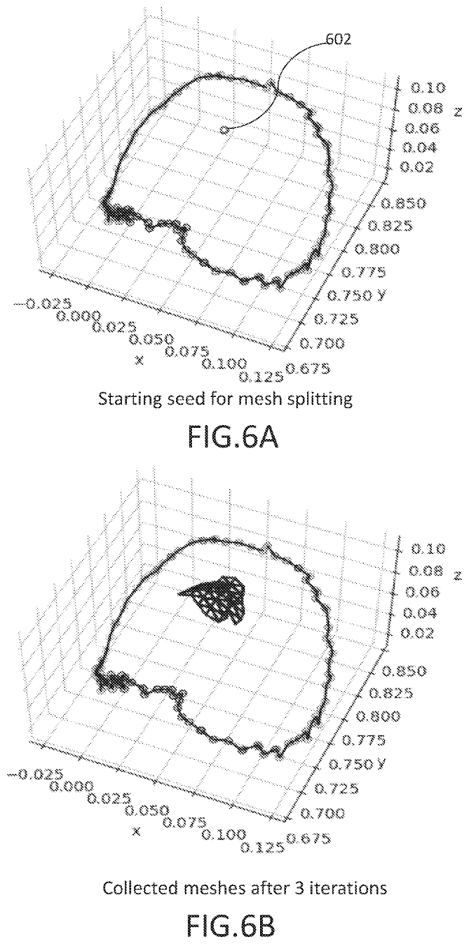

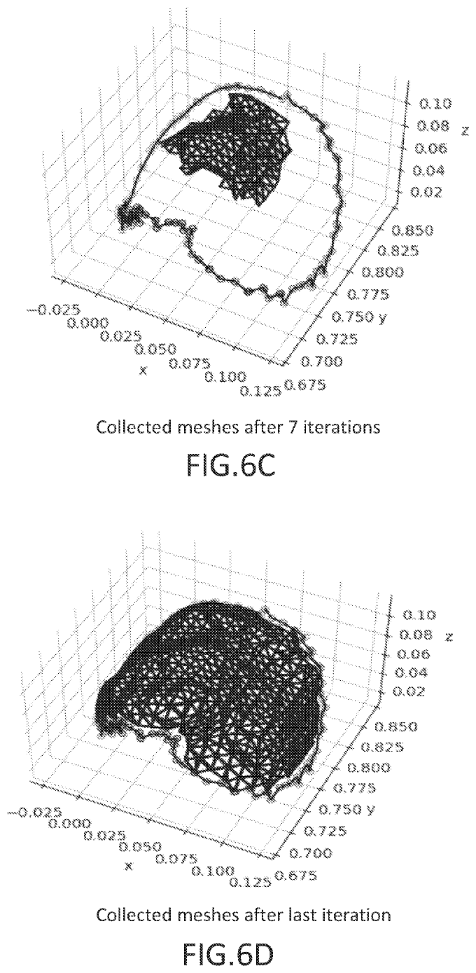

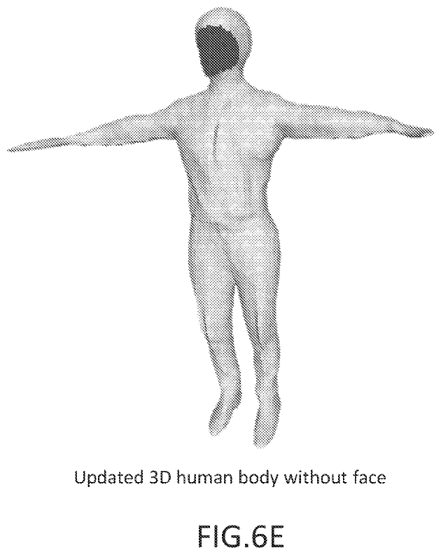

Mesh splitting processing between front face and non-front-face human body is shown in FIG. 6A-6D . This process can be performed on the original 3D human body model. An initial 3D point is selected from the front face as a starting point for the algorithm to apply a watershed algorithm. This initial point is a significant point in the front face. While any point within the front face would work, a 3D point substantially corresponding to a nose of the user is selected as a starting seed point and can be obtained using one or more face detection libraries such as Mediapipe and Dlib, which identify a position of the nose from a 2D face.

Upon identifying an initial 3D starting seed point 602, in FIG. 6A, the initial point data is stored into a queue. When processing begins, only one 3D point, the initial starting nose point 602, is in saved in memory in the queue. For each point saved in the queue, they are used as a pivot point to collect all the data representing the meshes associated with the pivot point, and all these meshes collected would belong to the front face that needs to be replaced. Then, all of the 3D points associated with the collected meshes are added into the queue we defined above. The pivot point would be removed once it went through the above two steps. This processing is iterated until the boundary points are reached and the queue was empty. The iterative processing performed by the watershed algorithm is illustrated in FIGS. 6B-6D . FIG. 6B illustrates meshes collected (or otherwise determined) after 3 algorithmic iterations. FIG. 6C illustrates meshes collected (or otherwise determined) after 7 iterations and FIG. 6D illustrates all meshes collected (or otherwise determined) after a last algorithmic iteration. This processing results in identifying all the meshes belonging to the front face and removes the data corresponding to the meshes from the entire human body model to arrive at the updated human body model without front face as shown in FIG. 6E.

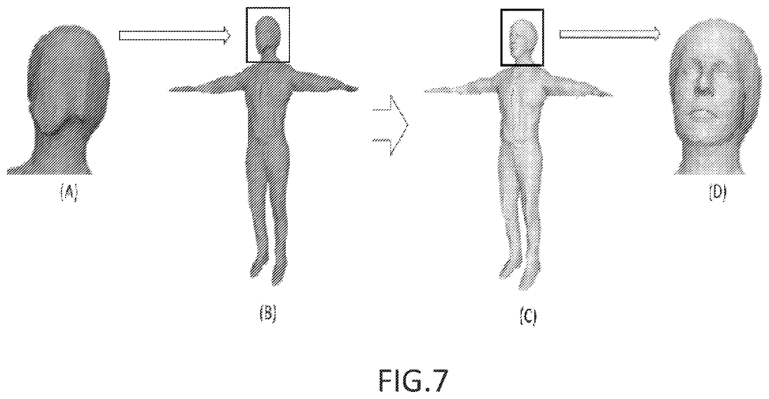

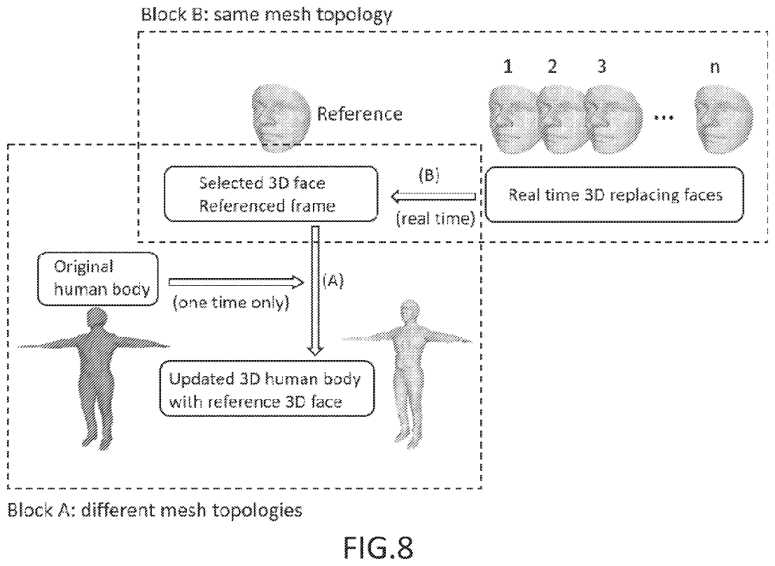

Real-time dynamic 3D face replacement 214 is shown in FIG. 7. FIG. 7 illustrates the performance of the 3D face replacement algorithm according to the present disclosure. The original 3D human body image obtained in 202 at the initial phase is replotted in (A) and (B) in FIG. 7. The updated one from a general non-front-face 3D human body and target 3D face used for replacement is shown in (C) and (D) in FIG. 7. As can clearly be observed from (A)-(D), the 3D face replacement algorithm according to the present disclosure successfully replaced the 3D face region in the original 3D human body and provided an overall better 3D face visualization for 3D human body. This processing is performed using real-time dynamic face replacement processing 214 described in FIG. 8.

3D face replacement processing is time-consuming and processing intensive resulting in difficulty when applied in a real-time environment. The algorithm according to the present disclosure improves this processing by eliminating the need, for a sequence of images, applying this processing to each image. More specifically, the algorithm according to the present disclosure allows for real-time implementation of the above face replacement for a sequence of images as illustrated in FIG. 8. To achieve real time face replacement, a first processing step is performed ((A) in FIG. 8) to select a reference frame from those target 3D face images used for replacement and selectively apply the approach described above to obtain the 3D boundary points and the updated human body with the face replaced. This is applied for two sets of 3D points with different mesh topologies illustrated as Block A. Then for any incoming real-time target 3d faces, alignment to the original 3D human body is not directly performed. Rather, the alignment is performed using the preselected reference frame, shown in step (B) in FIG. 8. In one embodiment, this alignment may be a linear transformation estimated using the corresponding 3D points between incoming frames and reference frame. Since this alignment is applied for two 3D points with the same mesh topology, illustrated as Block B, it is a rigid linear transformation which can computationally be performed in real time without sacrificing the quality of the replaced image. It is important to note that, while step A may be time consuming, all the results from this step, including the boundary determination and mesh splitting maybe saved for step B. Therefore, this step will cost almost no time for the face replacement on other 3D face images, making a real time implementation and overall performance thereof, advantageous.

The above face replacement algorithm advantageously performs 3D face replacement on an original 3d image derived from a 2D image. The algorithm advantageously enables replacement of a portion of the original image even when there is a different mesh topology between the image being used for replacement and the original 3d image on which replacement is being performed in real-time. This processing further enables replacement of not just a face portion of a 3D image but any other region of the image including eyes, hands, feet, etc. This successfully performs replacement in real time of at least one portion of a 3D object with another similar 3D image. The algorithm performs a first boundary detection processing that determines at least a first region of a 3D image to be replaced and a second boundary detection processing that refines the first boundary determination processing by searching and identifying 3D points in a gap area resulting from the first boundary processing. The second boundary processing is performed by searching for gap-filing 3D points using a local-region surface normal approach. Mesh splitting processing via watershed method is performed to split a first portion of the region being replaced from a second portion and aligning a target image with the first portion of the region in real time to generate an updated replaced image whereby the replaced region has an image quality higher than the original region identified for replacement.

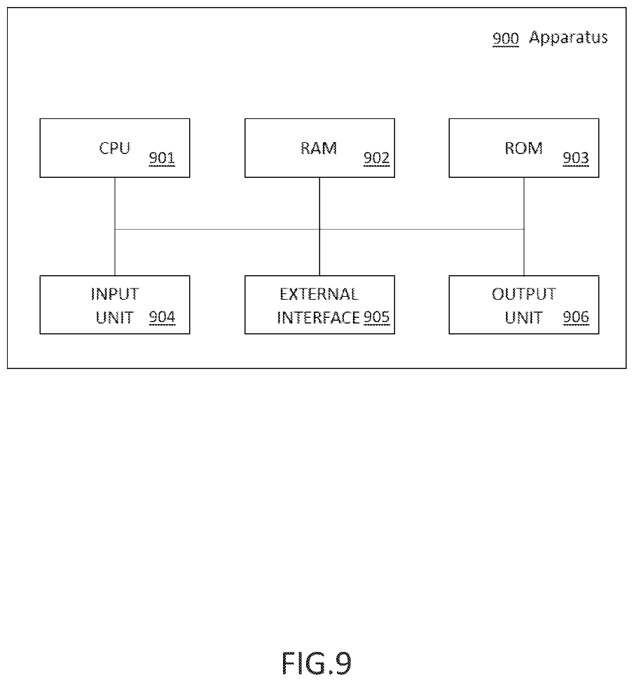

FIG. 9 illustrates the hardware that represents any of a server, a cloud service and/or client device that can be used in implementing the above described disclosure. The apparatus 900 includes a CPU 901, a RAM 902, a ROM 903, an input unit 904, an external interface 905, and an output unit 906. The CPU 901 controls the apparatus 900 by using a computer program (one or more series of stored instructions executable by the CPU 901) and data stored in the RAM 902 or ROM 903. Here, the apparatus 900 may include one or more dedicated hardware or a graphics processing unit (GPU), which is different from the CPU 901, and the GPU or the dedicated hardware may perform a part of the processes by the CPU 901. As an example of the dedicated hardware, there are an application specific integrated circuit (ASIC), a field-programmable gate array (FPGA), and a digital signal processor (DSP), and the like. The RAM 902 temporarily stores the computer program or data read from the ROM 903, data supplied from outside via the external interface 905, and the like. The ROM 903 stores the computer program and data which do not need to be modified and which can control the base operation of the apparatus 900. The input unit 904 is composed of, for example, a joystick, a jog dial, a touch panel, a keyboard, a mouse, or the like, and receives user's operation, and inputs various instructions to the CPU 901. The external interface 905 communicates with external device such as PC, smartphone, camera and the like. The communication with the external devices may be performed by wire using a local area network (LAN) cable, a serial digital interface (SDI) cable, WIFI connection or the like, or may be performed wirelessly via an antenna. The output unit 906 is composed of, for example, a display unit such as a display and a sound output unit such as a speaker, and displays a graphical user interface (GUI) and outputs a guiding sound so that the user can operate the apparatus as needed.

The scope of the present disclosure includes a non-transitory computer-readable medium storing instructions that, when executed by one or more processors, cause the one or more processors to perform one or more embodiments of the invention described herein. Examples of a computer-readable medium include a hard disk, a floppy disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can also be supplied to the computer-readable storage medium by being downloaded via a network.

The use of the terms “a” and “an” and “the” and similar referents in the context of this disclosure describing one or more aspects of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter disclosed herein and does not pose a limitation on the scope of any invention derived from the disclosure unless otherwise claimed. No language in the specification should be construed as indicating any non-claimed element as essential.

It will be appreciated that the instant disclosure can be incorporated in the form of a variety of embodiments, only a few of which are disclosed herein. Variations of those embodiments may become apparent to those of ordinary skill in the art upon reading the foregoing description. Accordingly, this disclosure and any invention derived therefrom includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. An information processing apparatus comprising:
one or more processors; and
one or more memories storing instructions that, when executed, configures the one or more processors, to:
receive a plurality of target 3D replacement images; select one of the plurality of the target 3D replacement images;
extract a portion of an identified replacement region in a 3D source image;
align the selected target 3D replacement image with the corresponding extracted region of the 3D source image;
determine a boundary by filling a gap of a boundary of the aligned selected target 3D replacement image and the 3D source image;
align a target 3D replacement image which is not selected to the corresponding extracted region of the 3D source image using the result of the boundary determination performed for the selected target 3D replacement image; and
generate an updated 3D image having the target 3D replacement image in the replacement region.

2. The information processing apparatus according to claim 1, wherein the one or more processors are further configured to detect a 3D boundary for the extraction of the identified region using information characterizing a first rough region of the 3D image.

3. The information processing apparatus according to claim 1, wherein the one or more processors are further configured to detect a boundary for the extraction of the identified region using one or more of a 2D boundary determination process and a 3D boundary determination process.

4. The information processing apparatus according to claim 1, wherein the one or more processors are further configured to refine the detected boundary by
identifying an area in an image having a gap on meshes between boundary data; and
filling the mesh gap using a local region surface process to re-define the replacement region.

5. The information processing apparatus according to claim 1, wherein the one or more processors are further configured to extract a portion of the identified replacement region by
generating meshes corresponding to a first region representing the replacement region in a human head and a second region representing all other regions not including the face in the replacement region; and
execute watershed mesh splitting to extract the first region representing the replacement region in a human head.

6. The information processing apparatus according to claim 1,
wherein the 3D source image includes a head region and a body region, wherein the head region includes a front head region and a back head region,
wherein a location of the head region on an XY plane is identified based on a prebuilt 2D face model, and
wherein the one or more processors are further configured to identify, as a rough replacement region in the 3D source image, the front head region based on a histogram of 3D points projected to a Z axis which is vertical to the XY plane, the 3D points being points of the head region.

7. The information processing apparatus according to claim 1,
wherein the one or more processors are further configured to perform alignment processing that includes first alignment processing and second alignment processing,
wherein, in the first alignment processing, the one or more processors are configured to apply 2D alignment based on the identified replacement region and the target 3D replacement image, and
wherein, in the second alignment processing, the one or more processors are configured to apply 3D alignment based on the identified replacement region and the target 3D replacement image.

8. The information processing apparatus according to claim 1,
wherein, after the target 3D replacement image and the identified replacement region of the 3D source image are aligned, the one or more processors searches boundary points from the identified replacement region in the 3D source image, and
wherein the one or more processors are configured to determine a boundary by obtaining gap-filling 3D points by connecting the searched boundary points and the gap-filling 3D points.

9. The information processing apparatus according to claim 8,
wherein the one or more processors are further configured to replot the boundary points by:
identifying two neighboring boundary points and a third 3D point from the one or more processors, wherein the two neighboring boundary points and the third 3D point configures a triangle mesh of the target 3D replacement image,
defining a local 3D coordinate system based on the identified two neighboring boundary points and the third 3D point,
projecting 3D points of the two neighboring boundaries in the local 3D coordinates, and
obtaining the gap-filling 3D points by applying a predetermined routing algorithm in the local 3D coordinates.

10. The information processing apparatus according to claim 1,
wherein the one or more processors are configured to perform:
receiving a plurality of the target 3D replacement images,
selecting one of the plurality of the target 3D replacement images, and
aligning the selected target 3D replacement image with the corresponding extracted region of the 3D source image,
wherein a target 3D replacement image which is not selected is aligned to the corresponding extracted region of the 3D source image using the result of the alignment of the selected target 3D replacement image.

11. (canceled)

12. An information processing method comprising:
receiving a plurality of target 3D replacement images; selecting one of the plurality of the target 3D replacement images;
extracting a portion of the identified replacement region in a 3D source image;
aligning the selected target 3D replacement image with the corresponding extracted region of the 3D source image; and
determining a boundary by filling a gap of a boundary of the aligned selected target 3D replacement image and the 3D source image;
aligning a target 3D replacement image which is not selected to the corresponding extracted region of the 3D source image using the result of the boundary determination performed for the selected target 3D replacement image; and
generating an updated 3D image having the target 3D replacement image in the replacement region.

13. The information processing method according to claim 12, further comprising:
detecting a 3D boundary for the extraction of identified region using information characterizing the first rough region of the 3D image.

14. The information processing method according to claim 12, further comprising: detecting a 3D boundary for the extraction of identified region using one or more of a 2D boundary determination process and a 3D boundary determination process.

15. The information processing method according to claim 12, further comprising
identifying an area in an image having a gap on meshes between boundary data;
filling a mesh gap using a local region surface process to re-define the replacement region.

16. The information processing method according to claim 12, further comprising extracting a portion of the identified replacement region by
generating meshes corresponding to a first region representing the replacement region in a human head and a second region representing all other regions not including the face in the replacement region;
executing watershed mesh splitting to extract the first region representing the replacement region in a human head.

17. The information processing method according to claim 12,
wherein the 3D source image includes a head region and a body region, wherein the head region includes a front head region and a back head region,
wherein a location of the head region on an XY plane is identified based on a prebuilt 2D face model, and further comprising
identifying, as a rough replacement region in the 3D source image, the front head region based on a histogram of 3D points projected to a Z axis which is vertical to the XY plane, the 3D points being points of the head region.

18. The information processing method according to claim 12, further comprising:
performing alignment processing that includes first alignment processing and second alignment processing,
wherein, the first alignment processing includes applying 2D alignment based on the identified replacement region and the target 3D replacement image, and
wherein, the second alignment processing includes applying 3D alignment based on the identified replacement region and the target 3D replacement image.

19. The information processing method according to claim 12, further comprising:
after the target 3D replacement image and the identified replacement region of the 3D source image are aligned, searching boundary points from the identified replacement region in the 3D source image, and
determining a boundary by obtaining gap-filling 3D points by connecting the searched boundary points and the gap-filling 3D points.

20. The information processing method according to claim 19, further comprising replotting the boundary points by
identifying two neighboring boundary points and a third 3D point, wherein the two neighboring boundary points and the third 3D point configures a triangle mesh of the target 3D replacement image,
defining a local 3D coordinate system based on the identified two neighboring boundary points and the third 3D point,
projecting 3D points of the two neighboring boundaries in the local 3D coordinates, and
obtaining the gap-filling 3D points by applying a predetermined routing algorithm in the local 3D coordinates.

21. The information processing method according to claim 12, further comprising
receiving a plurality of the target 3D replacement images,
selecting one of the plurality of the target 3D replacement images, and
aligning the selected target 3D replacement image with the corresponding extracted region of the 3D source image,
wherein a target 3D replacement image which is not selected is aligned to the a corresponding extracted region of the 3D source image using the result of the alignment of the selected target 3D replacement image.

22. (canceled)

23. A non-transitory computer readable medium storing instructions that, when executed by one or more processors, configures an information processing apparatus to perform the method of claims 12.
